(19) United States
(12) Patent Application Publication
(10) Pub. No.: US 2010/0185785 A1
(43) Pub. Date: Jul. 22, 2010

(54) AUTOMATIC MAPPING AND UPDATING COMPUTER SWITCHING DEVICE

(75) Inventors: Hung-June WU, Taipei Hsien (TW); Cheng-Sheng CHOU, Taipei Hsien (TW)

Correspondence Address: Muncy, Geissler, Olds & Lowe, PLLC, 4000 Legato Road, Suite 310, FAIRFAX, VA, 22033, US

(73) Assignee: JUNE-ON CO., LTD., Taipei Hsien (TW)

(21) Appl. No.: 12/749,878

(22) Filed: Mar. 30, 2010

Related U.S. Application Data
(63) Continuation-in-part of application No. 12/060,879, filed on Apr. 2, 2008.

(51) Int. Cl. G06F 3/00; G06F 13/12

(52) U.S. Cl. 710/11; 710/63

(57) ABSTRACT

The present invention relates to an automatic mapping and updating computer switch device. The computer switching device provides the compatibility between a plurality of devices and a plurality of computers, and comprises a USB Host Chip connected to the plurality of peripheral devices each containing a USB connector for sending the necessary data (USB device descriptor/report) to a plurality of USB Device Chips, thus, the computers can acquire the necessary data of the peripheral devices through the connected USB Device Chips. Whenever the computer switching device re-boots or any of the peripheral devices are plugged in/pulled out, the USB Host Chip reads the new necessary data again with the previous ones, if any differences are found, the new necessary data is send to the USB Device Chip for storage.

The aforesaid procedure is called DDM (Dynamic Devices Mapping) or full USB Enumeration or full USB Initiation.

This application is a Continuation-In-Part of my patent application Ser. No. 12/060,879, filed on Apr. 2, 2008.

### BACKGROUND OF THE INVENTION

1. Field of the Invention

The present invention relates to an automatic mapping and updating computer switching device, particularly, to the computer switching device that ensures the compatibility between a plurality of peripheral devices and a plurality of computers.

2. Description of the Related Art

When a computer fails to meet the operational requirement, adding a new computer or continuing to use the old one is the most common solution. But under the situations of limited space or budgets, these ideas often never come true. However, thanks to the rapid development of electronics and information technology, two or more computers, whether new or old, can share one keyboard, mouse, monitor and even one speaker, microphone and any other peripheral devices simply through connecting in series to a computer switch (KVM). In this way, the user can not only gain more work space for improving work efficiency, but also save the money to purchase the peripheral devices.

The so-called computer switch (KVM) is a switch that integrates the keyboard, video and mouse. In other words, it allows the user to switch among multiple computers at the same time by means of one keyboard, video and mouse set. The computer switch not only simplifies the operational equipment under multi-computer environment, but also allows the user to synchronously manage different computers or servers through rapid switching from one computer to another, without interruption of the operation of the computer when the switching is performed and making the operation easer.

However, since a USB-type computer switch available on the market is impossibly applied to all type of USB devices, it often leads to incompatibility and disconnection of the multi-function mouse, keyboard, joystick, touch screen or other USB human interface device (HID) with the computers. The devices enumeration, descriptors report analysis or other structural configuration of the USB-type computer switch are stimulated and converted to an established computer interface format, therefore, it cannot satisfy all USB devices. Additionally, the connection of the regular computer switch to the USB devices other than mouse and keyboard usually requires a USB hub. Therefore, when the above problem occurs, in addition to replacement with compatible USB devices, an updated control program version (with added stimulation and conversion functions) may be adopted as the solution for some computer switches. But the two methods cannot resolve the incompatibility problem completely. Besides, many companies currently store their confidential data and documents in computers. But due to wide-spread use of portable storage devices, these data and documents are subject to theft and disclosure; therefore, these companies disable, seal or remove USB ports of the computers in succession to prevent any disclosure. Under such circumstances, however, users will be confronted with operating difficulties when they need to gain access to these data or documents or connect to a certain peripheral (such as a printer or scanner). If the computer switch is used, it is impossible to disable, seal or remove USB ports. As a result, the confidential data and documents of the companies are very liable to theft or disclosure.

Therefore, it is desirable to provide an automatic mapping and updating computer switching device that eliminates the aforesaid problems.

### SUMMARY OF THE INVENTION

The present invention has been accomplished under the circumstances in view. It is therefore one object of the present invention to provide an automatic mapping and updating computer switching device which comprises a USB Host Chip connected to a plurality of peripheral device each containing a USB connector. The USB Host Chip can read the necessary data of the peripheral devices, or monitors and records the necessary data (USB device descriptor/report) while the necessary data of the peripheral devices are transmitted to the computers by a USB switch chip via a USB hub chip in order to gain and store the descriptors and necessary data including report analysis, enumeration, type or form, of the peripheral devices, then these necessary data are sent to a plurality of USB Device Chips for storage. Such that, when the computers communicate with the connected USB Device Chips, the USB Device Chips send the stored necessary data to the computers and enable the peripheral devices to perform the operations to the computers, and further, the computability between the peripheral devices and the computers is guaranteed.

According to another aspect of the present invention, when the computer switching device re-boots and any of the peripheral devices is plugged in or pulled out, the USB Host Chip will read and store the new necessary data (USB device descriptor/report) of the peripheral devices, and compares the it with the previous stored ones, and then, if any differences are found, the USB Host Chip will update the new necessary data to the USB Device Chips so that the connected computers can know the necessary data relating to the peripheral devices and the peripheral devices are compatible with the connected computers.

A further object of the present invention is to enable the memory in the USB host chip to store the limitations set by the administrator, which consist of the necessary data (USB device descriptors) of the peripheral devices, so that the USB host chip can transmit the necessary data to multiple USB device chips to enable connection of the peripheral devices with the computer only after the peripheral devices that meet the requirements for device type, brand, name or model as set in the limitations are connected. By doing so, only peripheral devices of the identified users are allowed to be connected to the computer, while other peripherals cannot be connected, thus achieving enhanced safety and improved operating convenience.

### BRIEF DESCRIPTION OF THE DRAWINGS

FIG. 1 is a block diagram of a computer switching device in accordance with the present invention.

FIG. 2 is a data transmission block diagram of the computer switching device in accordance with the present invention.

FIG. 3 is a block diagram of the computer switching device in accordance with another embodiment of the present invention.

FIG. 4 is a block diagram of the computer switching device according to another embodiment of the present invention.

FIG. 5 is a block diagram of the computer switching device according to a further embodiment of the present invention.

### DETAILED DESCRIPTION OF THE PREFERRED EMBODIMENT

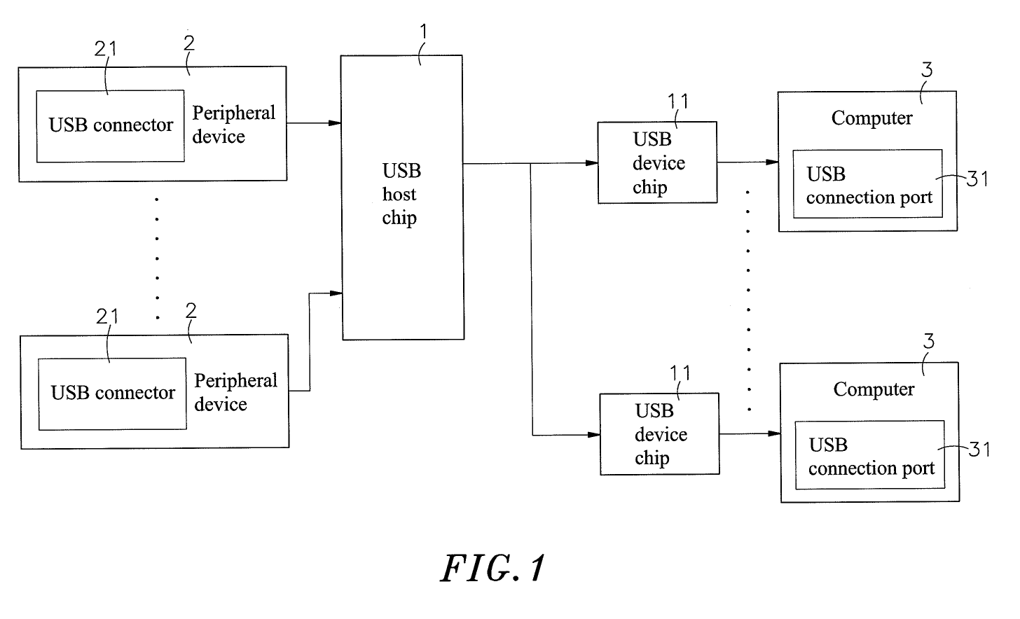

Referring to FIG. 1, an automatic mapping and updating computer switching device in accordance with the present invention is shown comprised of a USB Host Chip 1. The USB Host Chip 1 is provided for connecting with a plurality of peripheral devices 2 each containing a USB connector 21 and a plurality of USB Device Chips 11. The USB Device Chips 11 are further connected to a plurality of computers 3 each having a USB connection port 31.

When in use, the USB Host Chip 1 is stimulated as a host and fully communicates with the peripheral devices 2 connected to the computer switching device based on the standard USB communication protocol to read and store the descriptors and necessary data including report analysis, enumeration, type or form, of the peripheral devices 2, wherein the descriptors include the configuration descriptor, interface descriptor, class descriptor and endpoint descriptor. Then these necessary data are transmitted to the USB Device Chips 11 for storage, so that the computers 3 can acquire the accurate data of the peripheral devices 2 through the USB Device Chips 11 and enable the peripheral devices 2 to perform the operations. Therefore, it likes that the computers 3 and the peripheral devices 2 are connected together directly, without problem of incompatibility occurred in the peripheral devices 2 with different categories, types or functions of (such as mouse, keyboard, joystick, touch screen, hub or other device with USB connection interface).

If the computer switching device re-boots or any peripheral device 2 is plugged in or pulled out, the USB Host Chip 1 will communicate with the peripheral devices 2 based on the standard USB communication protocol for reading and storing the necessary data again, and compare the new data with the old ones; if no differences are found, it will not update the USB Device Chips 11, on the contrary, if any differences are found, it will map the new data into the USB Device Chips 11 to update the connected computers 3. Thus, the computers 3 can know the data of the peripheral devices 2 currently connected to the USB Host Chip 1. In the case that the USB Device Chips 11 are not connected to the computers 3 or the computers 3 are not started, after connecting or starting, the USB Device Chips 11 will update the data of the peripheral devices 2 into the computers 3 and enable the peripheral devices 2 to perform the operations, without the problem of incompatibility.

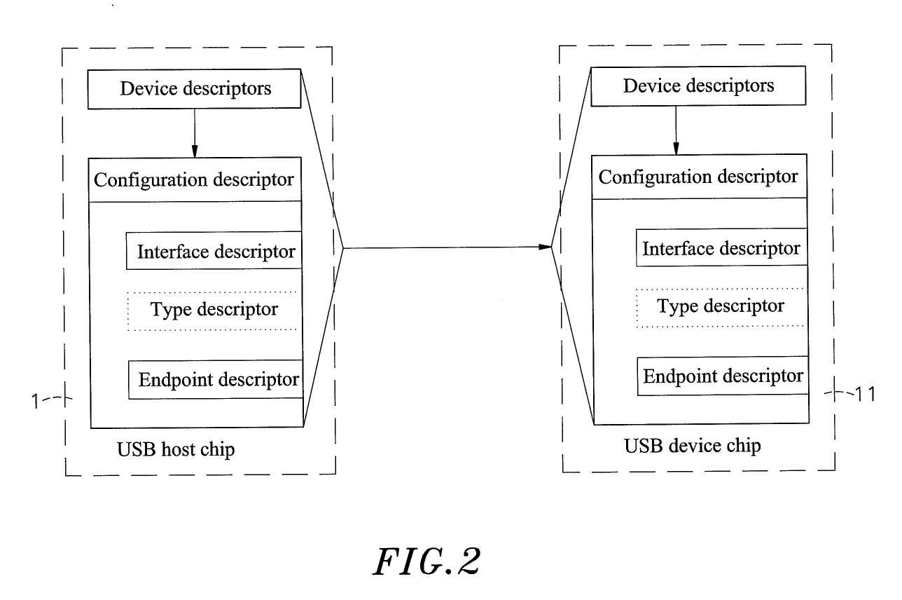

Referring to FIG. 2, the necessary data of the peripheral devices 21 read by the USB Host Chip 1 are sent to the USB Device Chips 11 through internal data transmission lines. The necessary data is device descriptors containing configuration descriptor, interface descriptor, type descriptor and terminal descriptor.

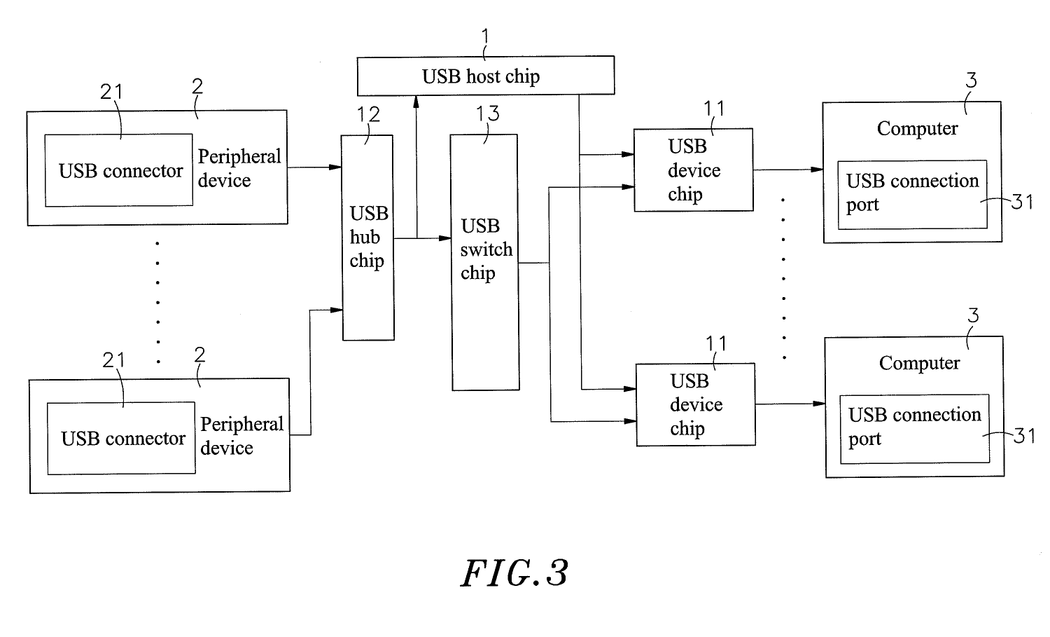

FIG. 3 is a block diagram in accordance with another embodiment of the present invention. The embodiment is substantially similar to the aforesaid embodiment with the exception of a USB hub chip 12 and a USB switch chip 13. The USB hub chip 12 is connected with the peripheral devices 2. Besides, the USB hub chip 12 is further electrically connected to the USB Host Chip 1 and the USB switch chip 13. The USB switch chip 13 is further connected to the USB Device Chips 11.

When the computer switching device is connected to the peripheral devices 2 and the computers 3, first, allow one of the computers 3 (which may be a computer started at the earliest or a specific computer) be directly connected to the peripheral devices 2 for data transmission, at this time, the data of the peripheral devices 2 are transmitted through the USB hub chip 12 to the USB switch chip 13 and further to a pre-determined USB Device Chip 11 so that the computer 3 connected with the pre-determined USB Device Chip 11 could perform the operations to the peripheral devices 2. Meanwhile, the USB Host Chip 1 will carry out monitoring and recording to obtain and store report analysis, enumeration, type, form or other necessary data of the peripheral devices 2. Then, these necessary data of the peripheral devices 2 are transmitted to other USB Device Chips 11 for storage via the data bus without switching through a switching chip. Hereafter, after the USB Device Chips 11 are connected to the computers 3, the USB Device Chips 11 will transmit the stored necessary data of the peripheral devices 2 to the connected computers 3 to ensure each of the computers 3 stores the same necessary data of the peripheral devices 2, achieving the objective that the peripheral devices 2 can perform the operations to the plurality of computers successfully.

The USB Host Chip 1 and the plurality of USB Device Chips 11 can be not only installed on a circuit board inside the computer switching device but also constructed inside a semiconductor chip to form an Application Specific Integrated Circuit (ASIC) or a commercial application integrated circuit to reduce the size and for easy assembly.

Along with the popularization of USB devices, like mobile disks, external hard drives, music players, mobile phones, mice, keyboards and other electronic devices with USB connection ports, a plurality of USB devices connected with the computer switching device can be inserted and removed frequently due to the plug-and-play characteristics. The USB Host Chip 1 of the present invention can read and store the report analysis, enumeration, type, form or other necessary data of the peripheral devices 2, and then transmits these the necessary data to the USB Device Chips 11 for storage, which are correspondingly connected to the computers 3 one to one, so that the computers 3 can receive the same necessary data regarding the peripheral devices 2. Thus, the problem of incompatibility resulted from the insertion or removal of the peripheral devices 2 can be avoided and the convenience in use of the computer switching device is improved, preventing the computers 3 from breakdown, errors or other faults raising out of incompatibility of the peripheral devices 2, and enhancing people's desire to use the computer switching device.

The computer switching device may be a switch, an extender or a distributor, provided that it has the function of connecting the peripheral devices 2 and the computers 3.

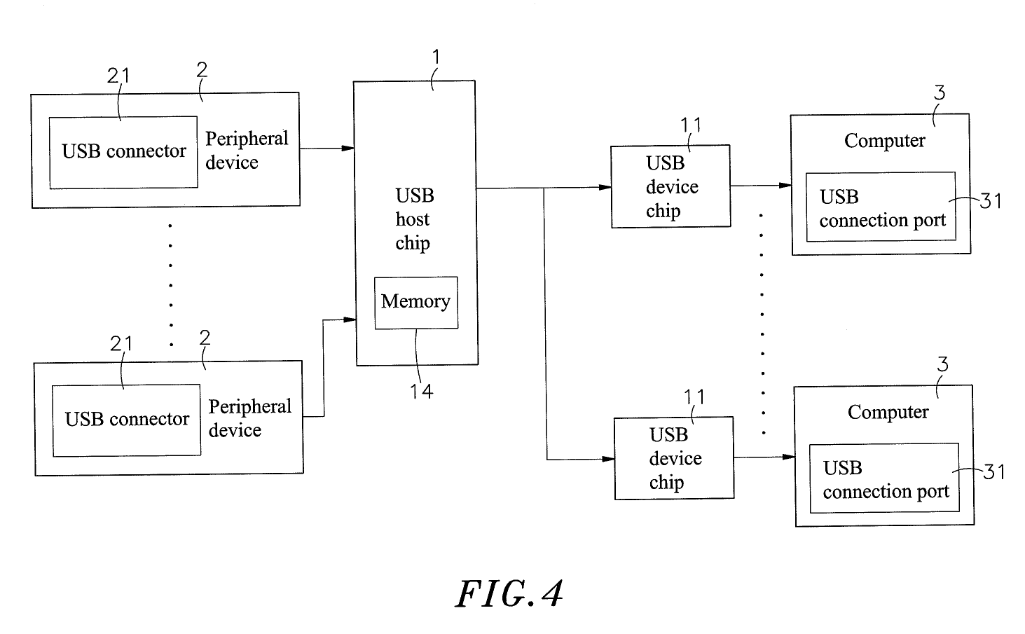

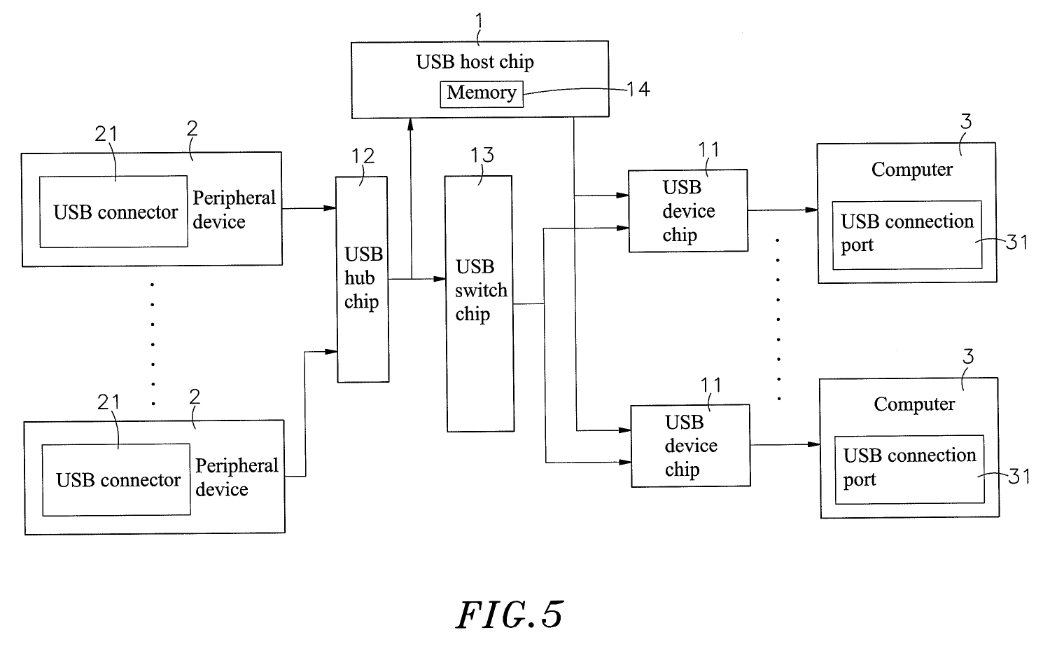

Refer to FIGS. 4-5 which are block diagrams of the computer switching device according to another two embodiments of the present invention. As shown clearly in both figures, the USB host chip 1 contains a memory 14 inside to store the necessary data of the peripheral devices 2 as the preset limitations. After the peripheral devices 2 are connected to the computer switching device, the USB host chip 1 will read the necessary data of the peripheral devices 2 or those received from the USB hub chip 12 at first, and compare these data with the necessary data that serve as the limitations in the memory 14. Then, when a designated peripheral device 2 is connected through active control of authorization or passive control of non-authorization/inhibition, the USB host chip 1 will transmit the necessary data of the connected peripheral device 2 to a plurality of USB device chips 11; otherwise, if an unidentified peripheral device 2 is connected, the USB host chip 1 will not process or transmit the necessary data of this peripheral device 2.

The necessary data stored in the aforesaid memory 14 as the preset limitations are the device descriptors of the peripheral devices 2, which may be the device class/device type, device brand, product name or model number, etc. and enables the peripheral devices 2 of a certain type (e.g. keyboards) to be connected for use, or limit the peripheral devices 2 of a specific brand or even a specific product or model to be used. Since users utilize the peripheral devices 2 steadily in most cases, such limitation will play a controlling role and prevent unauthorized persons from directly operating the computers 3 by using the peripheral devices 2, such as mice, keyboards or mobile memory devices, thus achieving the purposes of enhanced safety and improved operating convenience.

The preset limitations stored in the memory 14 can be set by the administrator on his/her own, and the administrator can finish settings in this regard by using the specific programming interface of high safety, OSD (On-Screen-Display) operating interface embedded in the computer switching device or hot keys on the keyboard. Because the preset limitations can be changed only through specific methods, it will prevent unauthorized persons from using the peripheral devices 2 in addition to blocking them from changing the preset limitations, thus enhancing the safety of the computers.

In actual practice, the automatic mapping and updating computer switching device of the present invention has the following features and advantages:

1. The USB Host Chip 1 can directly read the descriptors and necessary data including report analysis, enumeration, type or form of the peripheral devices 2 with the USB connectors 21, or monitor and record the transmission of these necessary data by the USB hub chip 12 to the computers 3 via the USB switch chip 13 to acquire and store the necessary data of the peripheral devices 2, and then transmits these necessary data to the USB Host Chips 11. Such that, each computer 3 can obtain the correct data regarding the peripheral devices 2 from the computer interface microprocessor 11, and enable the peripheral devices 2 compatible with the plurality of computers 3 to perform the operation successfully.

2. When the computer switching device re-boots or any peripheral device 2 is plugged in or pulled out, the USB Host Chip 1 will read and store the necessary data of the peripheral devices 2 again, and compares the new data with the previously stored ones; if any differences are found, the USB Host Chip 1 will map the new data into the USB Device Chips 11 for updating so that the computers 3 can always get the latest necessary data of the peripheral devices 2 through the USB Device Chips 11. Thus, the peripheral devices 2 can be compatible with the computers 3 after plugging in/pulling out and updating.

3. The administrator can set and store the limitations that comprise the necessary data of the peripheral devices 2 (device descriptors) in the memory 14 of the USB host chip 1 to exercise active or passive control, so as to ensure that the USB host chip 1 will transmit the necessary data of a specified peripheral device 2 to multiple USB device chips 11 for connection with the computers 3 only after the peripheral device 2 is connected. This will prevent others from accessing the data or documents in the computers 3 or changing the settings without permission through connection to the peripheral devices 2, while the regular peripheral devices 2 utilized by authorized users can be connected successfully to the computers 3.

In general, the invention provides an automatic mapping and updating computer switching device, which uses a USB Host Chip 1 to read and store necessary data of a plurality of peripheral devices 2 with USB connectors 21, and sends the necessary data to a plurality of USB Device Chips 11 so that each of a plurality of computers 3 can read the necessary data of the peripheral devices 2 from the USB Device Chips 11. Therefore, the peripheral devices 2 are really compatible with the computers 3.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. An automatic mapping and updating computer switching device, particularly said computer switching device capable of making a plurality of peripheral devices each containing a USB connector compatible with a plurality of computers when connecting, comprising:
a USB Host Chip, said USB Host Chip (or call USB Host Chip) electrically connected to said peripheral devices; and
a plurality of USB Device Chips, said USB Device Chips (or call USB Device Chip) electrically connected to said USB Host Chip and said computers each having a USB connection port;
wherein after a communication is established between said USB Host Chip and said peripheral devices, said USB Host Chip starts to read, store, map and transmit necessary data of said peripheral devices to said USB Device Chips and the necessary data are further transmitted to said computers; when said computer switching device re-boots or any of said peripheral devices is plugged in/pulled out, said USB Host Chip will read and store new necessary data of current peripheral devices again and further compares the new necessary data with the previous ones, and if any differences are found, the new necessary data are mapped into said USB Device Chips for updating said computers; said procedure is full USB Enumeration or full USB Initiation; said USB host chip includes a memory to store necessary data of said peripheral devices as preset limitations, so that said USB host chip is required to compare the necessary data of said peripheral devices with the preset limitations after having read these data; for any correspondence, said USB host chip will map and update the necessary data of said peripheral devices that have been connected into a plurality of USB device chips via the data bus;

2. The automatic mapping and updating computer switching device as claimed in claim 1, wherein said USB Host Chip makes complete communication with said peripheral devices based on the standard USB communication protocol after it has been stimulated as a host.

3. The automatic mapping and updating computer switching device as claimed in claim 1, wherein said necessary data include descriptors and report analysis, enumeration, type or form, while device descriptors comprise the configuration descriptor, interface descriptor, class descriptor and endpoint descriptor.

4. The automatic mapping and updating computer switching device as claimed in claim 1, wherein said USB host chip is based on active control of authorization or passive control of non-authorization/inhibition to make a comparison between the preset limitations and the necessary data; the preset limitations may be the device class/device type, device brand, product name or model number, and the administrator can finish settings in such regard by using the specific programming interface, OSD operating interface embedded in the computer switching device or hot keys on the keyboard.

5. An automatic mapping and updating computer switching device, particularly said computer switching device capable of making a plurality of peripheral devices each containing a USB connector compatible with a plurality of computers after connecting, comprising a USB Host Chip, a plurality of USB Device Chips, a USB hub chip and a USB switch chip, wherein:
said USB Host Chip is electrically connected to said USB hub chip and contains a memory to store necessary data of a specified peripheral device as preset limitations, so that said USB host chip is required to make a comparison between the necessary data received from said USB hub chip and the preset limitations; and said USB host chip transmits the necessary data to said USB device chips only after correspondence is found;
said USB Device Chips are electrically connected to said computers each having a USB connection port, and after receiving and storing the necessary data from said USB Host Chip, said USB Device Chips transmit the necessary data to said connected computers;
said USB hub chip is electrically connected to said peripheral devices, and after receiving the necessary data of said peripheral devices, said USB hub chip transmits the necessary data to said USB switch chip and said USB Host Chip; and
said USB switch chip is electrically connected to said USB Device Chips for sending the received necessary data to one of said USB Device Chips.

6. The automatic mapping and updating computer switching device as claimed in claim 1, wherein said necessary data includes descriptors and report analysis, enumeration, type or form, and the descriptors comprise the configuration descriptor, interface descriptor, class descriptor and endpoint descriptor.

7. The automatic mapping and updating computer switching device as claimed in claim 5, wherein said USB host chip can make a comparison between the preset limitations and the necessary data by using active control of authorization or passive control of non-authorization/inhibition; the preset limitations may be the device class/device type, device brand, product name or model number, and the administrator finishes settings in such regard by using the specific programming interface, OSD operating interface embedded in the computer switching device or hot keys on the keyboard.
